(19) United States
(12) Patent Application Publication
(10) Pub. No.: US 2016/0325589 A1
(43) Pub. Date: Nov. 10, 2016

(54) Tire Including A Set Of One Or More Knitted Fabrics

(71) Applicants: COMPAGNIE GENERALE DES ETABLISSEMANT MICHELIN, Clermont-Ferrand (FR); MICHELIN RECHERCHE ET TECHNIQUE S.A., Granges-Paccot (CH)

(72) Inventors: Christophe LE CLERC, Clermont-Ferrand Cedex 9 (FR); Richard CORNILLE, Clermont-Ferrand Cedex 9 (FR); Geneviève PINEAU, Clermont-Ferrand Cedex 9 (FR); Xavier LEGRAND, Clermont-Ferrand Cedex 9 (FR); Hubert OSTYN, Clermont-Ferrand Cedex 9 (FR); Marc-Antoine COLOT, Clermont-Ferrand Cedex 9 (FR); Guillaume TANCHAUD, Clermont-Ferrand Cedex 9 (FR)

(21) Appl. No.: 15/108,498

(22) PCT Filed: Nov. 27, 2014
(86) PCT No.: PCT/EP2014/075759

§ 371 Date: Jun. 27, 2016

(30) Foreign Application Priority Data
Dec. 26, 2013 (FR) 1363595

(51) Int. Cl. B60C 9/11; B60C 15/00; B60C 9/18

(52) U.S. Cl. CPC B60C 9/11; B60C 9/1807; B60C 15/0018; B60C 2015/0639

(57) ABSTRACT

The tire (10) comprises at least one set (45) of at least two layers of at least one knit (44₁, 44₂), the two layers being at least partially superposed on one another. The knit (44₁, 44₂) comprises: columns of loops arranged one after the other substantially in an overall direction (X1) referred to as the main direction, rows of loops arranged one beside the other substantially in an overall direction (Z1) referred to as the transverse direction. The knit (44₁, 44₂) has a force at 100% elongation less than or equal to 40 N·row⁻¹ and/or 40 N·column⁻¹, the force at 100% elongation being determined from a force-elongation curve obtained by applying standard ISO 13934-1:2013 to the or each knit (44₁, 44₂) embedded in the standard elastomer matrix and the number of rows and/or columns being measured in accordance with standard NF EN 14971.

The subject of the invention is a tire comprising a set of layers of one or more knits and a method of manufacturing such a tire.

The invention applies to any type of vehicle but is preferably intended for passenger vehicles, two-wheeled vehicles such as motorcycles or bicycles, industrial vehicles selected from vans, heavy vehicles such as “heavy duty vehicles”—i.e. underground trains, buses, road haulage vehicles (lorries, tractors, trailers), off-road vehicles, agricultural vehicles or civil engineering plant, aircraft, other transport or handling vehicles.

A passenger vehicle tire comprising a carcass reinforcement anchored in two beads and surmounted radially by a crown comprising a crown reinforcement and a tread, the latter being connected to the beads by two sidewalls is known from the prior art.

Tire manufacturers are constantly seeking to increase the cornering stiffness of the tire in order to improve the handling of the tires, particularly when heavily loaded under cornering. A number of solutions have been implemented for this purpose.

A first solution is to provide the tire with a carcass reinforcement that comprises two carcass plies. A second solution is to increase the thickness of the sidewalls. However, the cornering stiffness of a tire using the first solution can still be improved upon and the mass of the tire using the second solution is relatively high.

One object of the invention is a tire that has the highest possible cornering stiffness under high load but without further increasing the mass as compared with tires using the first and second solutions described hereinabove.

To that end, one subject of the invention is a tire comprising at least one set of at least two layers of at least one knit, the two layers being at least partially superposed on one another, the or each knit comprising:

columns of loops, the loops of one and the same column being arranged one after the other substantially in an overall direction referred to as the main direction,

rows of loops, the loops of one and the same row being arranged one beside the other substantially in an overall direction referred to as the transverse direction, the or each knit having a force at 100% elongation less than or equal to 40 N·row⁻¹ and/or 40 N·column⁻¹, the force at 100% elongation being determined from a force-elongation curve obtained by applying standard ISO 13934-1:2013 to the or each knit embedded in the standard elastomer matrix and the number of rows and/or columns being measured in accordance with standard NF EN 14971.

By definition, a knit is a reinforcing element comprising stitches. Each stitch comprises a loop interlaced with another loop. Thus, a distinction is made between a knit which is a textile made up of stitches and a woven fabric which is a textile comprising weft threads and warp threads, the weft threads being substantially parallel to one another and the warp threads likewise being substantially parallel to one another.

A distinction is made between weft-knitted knits and warp-knitted knits. In weft knits the stitches are essentially formed in the direction in which the loops of one and the same row are arranged next to one another (across the width of the knit). In warp knits the stitches are essentially formed in the direction in which the loops of one and the same column (wale) are arranged next to one another (along the length of the knit).

There are different constructions. A construction means the way in which the threads that form a repeating pattern in the knit are interlaced. Constructions include, nonlimitingly, jersey, welted jersey, 1×1 rib, poker rib, interlocked rib, moss stitch in the case of weft knits and locknit, and atlas in the case of warp knits.

Thanks to the set, the tire according to the invention has a high cornering stiffness higher than that of the tires of the first and second solutions while at the same time being lighter in weight as demonstrated by the results of the comparative tests described hereinbelow.

Standard ISO 13934-1:2013 indicates how to obtain the force-elongation curve for the or each knit of the tire according to the invention. The standard indicates precisely how, from this force-elongation curve, to determine the elongation at break and the maximum force, notably defining the number of tests, the calculation, and how to express the results relating to these parameters. A person skilled in the art will be just as capable, using this force-elongation curve, of determining the forces at 100%, 50%, 10% elongation, of calculating and expressing the results relating to these parameters in exactly the same way. In particular, the force-elongation curve is produced for test specimens with a width equal to 50 mm±0.5 mm and a length that allows a test length equal to 100 mm±1 mm.

The standard elastomer matrix is a composition that has an apparent modulus MA100 at 100% elongation (namely a modulus calculated with respect to the initial cross section of the test specimen), measured in accordance with standard ASTM D412-1998, test specimen “C”, equal to 1.6 MPa±0.2 MPa, namely ranging from 1.4 to 1.8 MPa. Standard ISO 13934 1:2013 indicates that the measurements need to be taken over 2 sets of at least 5 test specimens. For each layer, each test specimen is manufactured by interposing each layer of knit taken from the material between two layers of the standard elastomer matrix. Each layer of the standard elastomer matrix has a thickness substantially equal to 0.4 mm. The test specimen thus formed by the layer of knit and the two layers of standard elastomer matrix is cured for 15 min at 160° C. under a pressure of 2.4 bar.

Standard NF EN 14971 states how to determine the number of columns and rows per unit length. Thus, a value for a parameter (force at 10%, 50%, 100% elongation and maximum force) per row is obtained by dividing the value obtained by applying standard ISO 13934-1:2013 to the or each knit embedded in a standard elastomer matrix in the direction of the columns by the number of rows per unit length multiplied by the width of the test specimen. Similarly, the value for a parameter per column is obtained by dividing the force obtained by applying standard ISO 13934-1:2013 to the or each knit embedded in a standard elastomer matrix in the direction of the rows by the number of columns per unit length multiplied by the width of the test specimen.

In order to achieve the properties described hereinbelow, the person skilled in the art will know how to vary certain parameters of the or each knit, such as the construction and certain parameters of the method of manufacturing the or each knit such as the type of loom used, the gauge of the loom and the course count in the case of weft knits.

According to other preferred features of the tire:
The or each knit has a force at 100% elongation less than or equal to 35 N·row⁻¹ and/or 35 N·column⁻¹, the force at 100% elongation being determined from a force-elongation curve obtained by applying standard ISO 13934-1:2013 to the or each knit embedded in the standard elastomer matrix and the number of rows and/or columns being measured in accordance with standard NF EN 14971.
The or each knit has a force at 100% elongation greater than or equal to 0.5 N·row⁻¹ and/or 0.5 N·column⁻¹, preferably 5 N·row⁻¹ and/or 5 N·column⁻¹ and more preferably 15 N·row⁻¹ and/or 15 N·column⁻¹, the force at 100% elongation being determined from a force-elongation curve obtained by applying standard ISO 13934-1:2013 to the or each knit embedded in the standard elastomer matrix and the number of rows and/or columns being measured in accordance with standard NF EN 14971.

According to other preferred features of the tire:
The or each knit has a force at 50% elongation greater than or equal to 0.5 N·row⁻¹ and/or 0.5 N·column⁻¹, preferably 2.5 N·row⁻¹ and/or 2.5 N·column⁻¹ and more preferably 10 N·row⁻¹ and/or 10 N·column⁻¹, the force at 50% elongation being determined from a force-elongation curve obtained by applying standard ISO 13934-1:2013 to the or each knit embedded in the standard elastomer matrix and the number of rows and/or columns being measured in accordance with standard NF EN 14971.
The or each knit has a force at 50% elongation less than or equal to 25 N·row⁻¹ and/or 25 N·column⁻¹, preferably 20 N·row⁻¹ and/or 20 N·column⁻¹, the force at 50% elongation being determined from a force-elongation curve obtained by applying standard ISO 13934-1:2013 to the or each knit embedded in the standard elastomer matrix and the number of rows and/or columns being measured in accordance with standard NF EN 14971.

According to other preferred features of the tire:
The or each knit has a force at 10% elongation greater than or equal to 0.05 N·row⁻¹ and/or 0.05 N·column⁻¹, preferably 1 N·row⁻¹ and/or 1 N·column⁻¹ and more preferably 2 N·row⁻¹ and/or 2 N·column⁻¹, the force at 10% elongation being determined from a force-elongation curve obtained by applying standard ISO 13934-1:2013 to the or each knit embedded in the standard elastomer matrix and the number of rows and/or columns being measured in accordance with standard NF EN 14971.
The or each knit has a force at 10% elongation less than or equal to 9 N·row⁻¹ and/or 9 N·column⁻¹, preferably 7 N·row⁻¹ and/or 7 N·column⁻¹, the force at 10% elongation being determined from a force-elongation curve obtained by applying standard ISO 13934-1:2013 to the or each knit embedded in the standard elastomer matrix and the number of rows and/or columns being measured in accordance with standard NF EN 14971.

According to other preferred features of the tire:
The or each knit has a maximum force greater than or equal to 5 N·row⁻¹ and/or 5 N·column⁻¹, preferably 10 N·row⁻¹ and/or 10 N·column⁻¹ and more preferably 30 N·row⁻¹ and/or 30 N·column⁻¹, the maximum force being measured in accordance with standard ISO 13934-1:2013 applied to the or each knit embedded in the standard elastomer matrix and the number of rows and/or columns being measured in accordance with standard NF EN 14971.
The or each knit has a maximum force less than or equal to 70 N·row⁻¹ and/or 70 N·column⁻¹, preferably 60 N·row⁻¹ and/or 60 N·column⁻¹, the maximum force being measured in accordance with standard ISO 13934-1:2013 applied to the or each knit embedded in the standard elastomer matrix and the number of rows and/or columns being measured in accordance with standard NF EN 14971.

For preference, the transverse overall direction of the or each knit is substantially parallel to the circumferential direction of the tire.

For preference, the main overall direction of the or each knit is substantially parallel to the radial direction of the tire.

In one preferred embodiment, the main directions of the knit or knits of each layer are substantially parallel to one another. In another preferred embodiment, the transverse directions of the knit or knits of each layer are substantially parallel to one another. As an alternative, the main directions of the knit or knits of each layer form a substantially non-zero angle in their pairs, and pairs of them are preferably substantially perpendicular. As an alternative, the transverse directions of the knit or knits of each layer form a substantially non-zero angle in their pairs, and pairs of them are preferably substantially perpendicular.

According to other preferred features of the tire:
The force at 100% elongation of the or each knit in the main direction and the transverse direction is greater than or equal to 0.5 N·row⁻¹ and 0.5 N·column⁻¹, preferably 5 N·row⁻¹ and 5 N·column⁻¹ and more preferably 15 N·row⁻¹ and 15 N·column⁻¹, the force at 100% elongation being determined from a force-elongation curve obtained by applying standard ISO 13934-1:2013 to the or each knit embedded in the standard elastomer matrix and the number of rows and columns being measured in accordance with standard NF EN 14971.
The force at 100% elongation of the or each knit in the main direction and the transverse direction is less than or equal to 40 N·row⁻¹ and 40 N·column⁻¹, preferably 35 N·row⁻¹ and 35 N·column⁻¹, the force at 100% elongation being determined from a force-elongation curve obtained by applying standard ISO 13934-1:2013 to the or each knit embedded in the standard elastomer matrix and the number of rows and columns being measured in accordance with standard NF EN 14971.

According to other preferred features of the tire:
The force at 50% elongation of the or each knit in the main direction and the transverse direction is greater than or equal to 0.5 N·row⁻¹ and 0.5 N·column⁻¹, preferably 2.5 N·row⁻¹ and 2.5 N·column⁻¹ and more preferably 10 N·row⁻¹ and 10 N·column⁻¹, the force at 50% elongation being determined from a force-elongation curve obtained by applying standard ISO 13934-1:2013 to the or each knit embedded in the standard elastomer matrix and the number of rows and columns being measured in accordance with standard NF EN 14971.
The force at 50% elongation of the or each knit in the main direction and the transverse direction is less than or equal to 25 N·row⁻¹ and 10 N·column⁻¹, preferably 20 N·row⁻¹ and 20 N·column⁻¹, the force at 50% elongation being determined from a force-elongation curve obtained by applying standard ISO 13934-1:2013 to the or each knit embedded in the standard elastomer matrix and the number of rows and columns being measured in accordance with standard NF EN 14971.

According to other preferred features of the tire:
The force at 10% elongation of the or each knit in the main direction and the transverse direction is greater than or equal to 0.05 N·row⁻¹ and 0.05 N·column⁻¹, preferably 1 N·row⁻¹ and 1 N·column⁻¹ and more preferably 2 N·row⁻¹ and 2 N·column⁻¹, the force at 10% elongation being determined from a force-elongation curve obtained by applying standard ISO 13934-1:2013 to the or each knit embedded in the standard elastomer matrix and the number of rows and columns being measured in accordance with standard NF EN 14971.
The force at 10% elongation of the or each knit in the main direction and the transverse direction is less than or equal to 9 N·row⁻¹ and 9 N·column⁻¹, preferably 7 N·row⁻¹ and 7 N·column⁻¹, the force at 10% elongation being determined from a force-elongation curve obtained by applying standard ISO 13934-1:2013 to the or each knit embedded in the standard elastomer matrix and the number of rows and columns being measured in accordance with standard NF EN 14971.

According to other preferred features of the tire:
The maximum force of the or each knit in the main direction and the transverse direction is greater than or equal to 5 N·row⁻¹ and 5 N·column⁻¹, preferably 10 N·row⁻¹ and 10 N·column⁻¹, more preferably 30 N·row⁻¹ and 30 N·column⁻¹, the maximum force being measured in accordance with standard ISO 13934-1:2013 applied to the or each knit embedded in the standard elastomer matrix and the number of rows and columns being measured in accordance with standard NF EN 14971.
The maximum force of the or each knit in the main direction and the transverse direction is less than or equal to 70 N·row⁻¹ and 70 N·column⁻¹, preferably 60 N·row⁻¹ and 60 N·column⁻¹, the maximum force being measured in accordance with standard ISO 13934-1:2013 applied to the or each knit embedded in the standard elastomer matrix and the number of rows and columns being measured in accordance with standard NF EN 14971.

According to other preferred features of the tire:
The or each knit has, in the main overall direction and/or the transverse overall direction, a force at 100% elongation that is greater than or equal to 50 N, preferably 200 N and more preferably 500 N, the force at 100% elongation being determined from a force-elongation curve obtained by applying standard ISO 13934-1:2013 to the or each knit embedded in the standard elastomer matrix.
The or each knit has, in the main overall direction and/or the transverse overall direction, a force at 100% elongation less than or equal to 1500 N, preferably 1400 N and more preferably 1300 N, the force at 100% elongation being determined from a force-elongation curve obtained by applying standard ISO 13934-1:2013 to the or each knit embedded in the standard elastomer matrix.

According to other preferred features of the tire:
The or each knit has, in the main overall direction and/or the transverse overall direction, a force at 50% elongation that is greater than or equal to 50 N, preferably 250 N, the force at 50% elongation being determined from a force-elongation curve obtained by applying standard ISO 13934-1:2013 to the or each knit embedded in the standard elastomer matrix.
The or each knit has, in the main overall direction and/or the transverse overall direction, a force at 50% elongation less than or equal to 1000 N, preferably 700 N, the force at 50% elongation being determined from a force-elongation curve obtained by applying standard ISO 13934-1:2013 to the or each knit embedded in the standard elastomer matrix.

According to other optional features of the tire:
The or each knit has, in the main overall direction and/or the transverse overall direction, a force at 10% elongation greater than or equal to 5 N, preferably 50 N, the force at 10% elongation being determined from a force-elongation curve obtained by applying standard ISO 13934-1:2013 to the or each knit embedded in the standard elastomer matrix.
The or each knit has, in the main overall direction and/or the transverse overall direction, a force at 10% elongation less than or equal to 700 N, preferably 600 N, the force at 10% elongation being determined from a force-elongation curve obtained by applying standard ISO 13934-1:2013 to the or each knit embedded in the standard elastomer matrix.

According to other preferred features of the tire:
The or each knit has, in the main overall direction and/or the transverse overall direction, a maximum force greater than or equal to 600 N, the maximum force being measured in accordance with standard ISO 13934-1:2013 applied to the or each knit embedded in the standard elastomer matrix.
The or each knit has, in the main overall direction and/or the transverse overall direction, a maximum force less than or equal to 2200 N, the maximum force being measured in accordance with standard ISO 13934-1:2013 applied to the or each knit embedded in the standard elastomer matrix.

According to other preferred features of the tire:
The or each knit has, in the main overall direction and/or the transverse overall direction, an elongation at break greater than or equal to 30%, preferably 100%, the elongation at break being measured in accordance with standard ISO 13934-1:2013 applied to the or each knit embedded in the standard elastomer matrix. Such an elongation at break is very much higher than a conventional woven fabric for which the elongation at break is of the order of 10% to 15% in the direction of the threads. Such an elongation allows the set to deform sufficiently even under extreme cornering loadings.
The or each knit has, in the main overall direction and/or the transverse overall direction, an elongation at break less than or equal to 1200%, preferably 250%, the elongation at break being measured in accordance with standard ISO 13934-1:2013 applied to the or each knit embedded in the standard elastomer matrix.

Advantageously, the features described hereinabove (force at 100%, 50% and 10% elongation, maximum force and elongation at break) can be observed in the main overall direction and/or the transverse overall direction. In an alternative form, they can be observed only in the main overall direction. In another alternative form, they can be observed only in the transverse overall direction. Finally, in a final alternative form, they can be observed in the main overall direction and the transverse overall direction.

According to other preferred features of the tire:

the force at 100% elongation of the or each knit in the main direction, determined from a force-elongation curve obtained by applying standard ISO 13934-1:2013 to the or each knit embedded in the standard elastomer matrix, is greater than or equal to 150 N, preferably 700 N and more preferably 1000 N, and

the force at 100% elongation of the or each knit in the transverse direction, determined from a force-elongation curve obtained by applying standard ISO 13934-1:2013 to the or each knit embedded in the standard elastomer matrix, is greater than or equal to 50 N, preferably 500 N.

According to other preferred features of the tire:

the force at 50% elongation of the or each knit in the main direction, determined from a force-elongation curve obtained by applying standard ISO 13934-1:2013 to the or each knit embedded in the standard elastomer matrix, is greater than or equal to 120 N, preferably 500 N, and

the force at 50% elongation of the or each knit in the transverse direction, determined from a force-elongation curve obtained by applying standard ISO 13934-1:2013 to the or each knit embedded in the standard elastomer matrix, is greater than or equal to 50 N, preferably 300 N.

According to other preferred features of the tire:

the force at 10% elongation of the or each knit in the main direction, determined from a force-elongation curve obtained by applying standard ISO 13934-1:2013 to the or each knit embedded in the standard elastomer matrix, is greater than or equal to 30 N, preferably 170 N, and

the force at 10% elongation of the or each knit in the transverse direction, determined from a force-elongation curve obtained by applying standard ISO 13934-1:2013 to the or each knit embedded in the standard elastomer matrix, is greater than or equal to 10 N, preferably 80 N.

According to other preferred features of the tire:

the elongation at break of the or each knit in the main direction measured in accordance with standard ISO 13934-1:2013 applied to the or each knit embedded in the standard elastomer matrix is less than or equal to 700%, preferably 250%, and

the elongation at break of the or each knit in the transverse direction measured in accordance with standard ISO 13934-1:2013 applied to the or each knit embedded in the standard elastomer matrix is less than or equal to 1200%, preferably 250%.

According to other preferred features of the tire:

the elongation at break of the or each knit in the transverse direction measured in accordance with standard ISO 13934-1:2013 applied to the or each knit embedded in the standard elastomer matrix is greater than or equal to 150%, and

the elongation at break of the or each knit in the transverse direction measured in accordance with standard ISO 13934-1:2013 applied to the or each knit embedded in the standard elastomer matrix is greater than or equal to 150%.

According to other preferred features of the tire:

the maximum force of the or each knit in the main direction measured in accordance with standard ISO 13934-1:2013 applied to the or each knit embedded in the standard elastomer matrix is greater than or equal to 600 N, and

the maximum force of the or each knit in the transverse direction measured in accordance with standard ISO 13934-1:2013 applied to the or each knit embedded in the standard elastomer matrix is greater than or equal to 600 N.

According to other preferred features of the tire:

the maximum force of the or each knit in the main direction measured in accordance with standard ISO 13934-1:2013 applied to the or each knit embedded in the standard elastomer matrix is less than or equal to 2200 N, and

the maximum force of the or each knit in the transverse direction measured in accordance with standard ISO 13934-1:2013 applied to the or each knit embedded in the standard elastomer matrix is less than or equal to 1500 N.

Advantageously, the main and transverse directions of the or each knit make, with respect to one another, an angle of between 75° and 105°, preferably between 85° and 95°.

In one embodiment, the surface density of stitches of the or each knit, measured in accordance with standard NF EN 14971, is less than or equal to 700 stitches·cm⁻², preferably to 100 stitches·cm⁻² and more preferably to 75 stitches·cm⁻².

In one embodiment, the surface density of stitches of the or each knit, measured in accordance with standard NF EN 14971, is greater than or equal to 15 stitches·cm⁻², preferably greater than or equal to 25 stitches·cm⁻² and more preferably, greater than or equal to 30 stitches·cm⁻².

For preference, the or each knit is made up of one or more filamentary elements of a material selected from a polyester, a polyamide, a polyketone, a polyvinyl alcohol, a cellulose, a mineral fibre, a natural fibre, an elastomeric material or a mixture of these materials.

Examples of polyesters include polyethylene terephthalate (PET), polyethylene naphthalate (PEN), polybutylene terephthalate (PBT), polybutylene naphthalate (PBN), polypropylene terephthalate (PPT) or polypropylene naphthalate (PPN). Examples of polyamides include an aliphatic polyamide such as nylon or an aromatic polyamide such as aramid. Examples of polyvinyl alcohols include Kuralon®. Examples of cellulose include rayon. Examples of mineral fibres include glass fibres and carbon fibres. Examples of natural fibres include hemp or flax fibres. Examples of elastomeric materials include Lycra®.

Advantageously, the or each filamentary element comprises at least one multifilament strand comprising several elementary monofilaments.

In an alternative form in which the or each knit comprises a plurality of multifilament strands, all the multifilament strands are made from the same material. In another alternative form in which the or each knit comprises a plurality of multifilament strands, the multifilament strands are made from at least two different materials.

In one embodiment, each filamentary element comprises a single multifilament strand referred to as an overtwist comprising several elementary monofilaments.

In another embodiment, each filamentary element comprises several multifilament strands, each one referred to as an overtwist, each one comprising several elementary monofilaments and assembled together in a helix to form a plied yarn.

For preference, each filamentary element has a tenacity greater than or equal to 30 cN·dtex⁻¹. For example, filamentary elements made of PET have one of the order of 70 cN·dtex⁻¹ and filamentary elements made of aramid have a tenacity of the order of 200 cN·dtex⁻¹.

Advantageously, each multifilament strand comprises between 2 and 2000 elementary monofilaments, preferably between 50 and 1000 elementary monofilaments.

Advantageously, the diameter of each elementary monofilament ranges from 10 μm to 100 μm, preferably from 10 μm to 50 μm and more preferably from 12 μm to 30 μm. Such a diameter makes it possible to obtain a knit that is relatively flexible and therefore compatible with use in a tire.

In another embodiment, each filamentary element comprises, is preferably made up of, a single monofilament.

For preference, the or each knit is coated with a layer of a tackifying adhesive. The adhesive used is for example of the RFL (resorcinol-formaldehyde-latex) type or, for example, as described in the publications WO2013017421, WO2013017422, WO2013017423.

In the tire, the or each knit is preferably embedded in an elastomer matrix. An elastomer (or rubber, the two terms being synonymous) matrix means a matrix comprising at least one elastomer.

For preference, the elastomer is a diene elastomer. As is known, diene elastomers can be classified into two categories: “essentially unsaturated” or “essentially saturated”. The term “essentially unsaturated” is understood to mean a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come under the above definition and can especially be described as “essentially saturated” diene elastomers (low or very low content of units of diene origin, always less than 15%). Within the “essentially unsaturated” category of diene elastomers a “highly unsaturated” diene elastomer particularly means a diene elastomer having a content of units of diene origin (conjugated dienes) which is higher than 50%.

Although it is applicable to any type of diene elastomer, the present invention is preferably carried out with a diene elastomer of the highly unsaturated type.

This diene elastomer is more preferably selected from the group consisting of polybutadienes (BRs), natural rubber (NR), synthetic polyisoprenes (IRs), various butadiene copolymers, various isoprene copolymers and mixtures of these elastomers, such copolymers being notably selected from the group consisting of butadiene/stirene copolymers (SBRs), isoprene/butadiene copolymers (BIRs), isoprene/stirene copolymers (SIRs) and isoprene/butadiene/stirene copolymers (SBIRs).

One particularly preferred embodiment consists in using an “isoprene” elastomer, that is to say an isoprene homopolymer or copolymer, in other words a diene elastomer selected from the group consisting of natural rubber (NR), synthetic polyisoprenes (IRs), various isoprene copolymers and mixtures of these elastomers. The isoprene elastomer is preferably natural rubber or a synthetic polyisoprene of the cis-1,4 type. Among these synthetic polyisoprenes, use is preferably made of polyisoprenes having a content (mol %) of cis-1,4 bonds of greater than 90%, even more preferably greater than 98%. According to one preferred embodiment, each layer of rubber composition contains 50 to 100 phr of natural rubber. According to other preferred embodiments, the diene elastomer may consist, in full or in part, of another diene elastomer such as, for example, an SBR elastomer used as a blend with another elastomer, for example of the BR type, or used alone.

The elastomer matrix may contain a single diene elastomer or several diene elastomers, the latter possibly being used in combination with any type of synthetic elastomer other than a diene elastomer, or even with polymers other than elastomers. The rubber composition may also contain all or some of the additives usually employed in rubber matrices intended for the manufacture of tires, such as, for example, reinforcing fillers such as carbon black or silica, coupling agents, antiageing agents, antioxidants, plasticizers or extension oils, whether the latter be of aromatic or nonaromatic nature (notably very weakly aromatic or non-aromatic oils, for example of the naphthene or paraffin type, of high or preferably low viscosity, MES or TDAE oils), plasticizing resins with a high Tg above 300° C., agents that improve the workability (processability) of the compositions in the raw state, tackifying resins, antireversion agents, methylene acceptors and donors such as HMT (hexamethylenetetramine) or H3M (hexamethoxymethylmelamine) for example, reinforcing resins (such as resorcinol or bismaleimide), known adhesion promoting systems of the metallic salts type, for example, notably salts of cobalt, nickel or lanthanide, a crosslinking or vulcanization system.

Preferably, the system for crosslinking the elastomer matrix is a system referred to as a vulcanization system, that is to say one based on sulphur (or on a sulphur donor agent) and a primary vulcanization accelerator. Various known vulcanization activators or secondary accelerators may be added to this basic vulcanization system. Sulphur is used at a preferred content of between 0.5 and 10 phr, and the primary vulcanization accelerator, for example a sulphenamide, is used at a preferred content of between 0.5 and 10 phr. The content of reinforcing filler, for example of carbon black or silica, is preferably greater than 50 phr, especially between 50 and 150 phr.

All types of carbon black, notably blacks of the HAF, ISAF, SAF type conventionally used in tires (so-called tire-grade blacks) are suitable for use as carbon blacks. Among the latter, more particular mention will be made of carbon blacks of (ASTM) grade 300, 600 or 700 (for example N326, N330, N347, N375, N683, N772). Precipitated or pyrogenated silicas having a BET surface area of less than 450 m²/g, preferably from 30 to 400 m²/g are notably appropriate for use as silicas.

A person skilled in the art will know, in the light of the present description, how to adjust the formulation of the rubber composition in order to reach the desired levels of properties (especially elastic modulus) and adapt the formulation to suit the specific application envisaged.

For preference, the elastomer matrix has, in the crosslinked state, a secant extension modulus at 10% elongation of between 4 and 80 MPa, more preferably of between 4 and 20 MPa. Modulus measurements are carried out under tension, unless otherwise indicated, in accordance with the standard ASTM D 412 of 1998 (test specimen “C”): the “true” secant modulus (that is to say the one with respect to the actual cross section of the test specimen) is measured in second elongation (that is to say after an accommodation cycle) at 10% elongation, denoted here by Ms and expressed in MPa (under standard temperature and relative humidity conditions in accordance with the standard ASTM D 1349 of 1999).

In one embodiment, the tire is for industrial vehicles selected from vans, heavy vehicles such as “heavy-duty vehicles”—i.e. underground trains, buses, road haulage vehicles (lorries, tractors, trailers), off-road vehicles, agricultural vehicles or civil engineering plant, aircraft, other transport or handling vehicles. In another embodiment, the tire is for a passenger vehicle. In yet another embodiment, the tire is for a two-wheeled vehicle.

For preference, the set is made up of several knits, each knit forming at least one layer of the set. For preference, the knits of the set are identical. However, it is also conceivable to use different knits within the set. As an alternative, the set comprises a single knit wound in several layers.

Advantageously, the layers are partially superposed in a radial and/or axial direction of the tire. Thus, when the set is arranged in the crown of the tire, the layers are preferably partially superposed in a radial direction of the tire. When the set is arranged in the sidewall of the tire, the layers are preferably partially superposed in an axial direction of the tire.

In a preferred embodiment, the tire comprises a carcass reinforcement anchored in two beads and surmounted radially by a crown reinforcement itself surmounted by a tread which is connected to the beads by two sidewalls, each sidewall comprising the set.

By positioning the set in the sidewall, the cornering stiffness of the tire is improved.

In one preferred embodiment, the radially outer end of the set is axially on the inside with respect to the axially outer end of the crown ply radially adjacent to the set.

In an even more preferred embodiment, the axial distance between the radially outer end of the set and the axially outer end of a crown ply radially adjacent to the set is greater than or equal to 5 mm, preferably greater than or equal to 10 mm, and more preferably greater than or equal to 15 mm.

In one preferred embodiment, the radially outer end of the set is interposed radially between the carcass reinforcement and the crown reinforcement. As an alternative, the radially outer end of the set is radially on the outside with respect to the crown reinforcement.

In certain embodiments, the carcass reinforcement is anchored in each bead by being turned up around an annular structure of the bead so as to form a main strand and a turnup.

In one particularly preferred embodiment, the radial distance between the radial inner end of the set and the radial mid-plane of the annular structure of the bead is less than or equal to 15 mm, preferably less than or equal to 10 mm, and more preferably less than or equal to 5 mm. Thus, if the sidewall becomes pinched against the rim, the set may prevent damage to the carcass reinforcement. The radial mid-plane is the plane that divides the annular structure into two parts of equal size in the radial direction.

In a first alternative form, the set extends, in the bead, axially between the main strand and the turnup of the carcass reinforcement.

In a second alternative form, the set extends, in the bead, axially on the outside of the turnup.

In other embodiments, the set is arranged axially on the inside of the carcass reinforcement.

In a preferred embodiment, the set forms a monolithic ring having an axis of revolution substantially parallel to the axis of the tire.

A monolithic ring means that each stitch of the or each knit is assembled with at least one other stitch of the same knit. Thus, in a monolithic ring, there is no overlap between the two ends of one and the same knit. Such a ring makes it possible to simplify the method of manufacture of the tire.

Another subject of the invention is the use of at least one set of at least two layers of at least one knit, the two layers being at least partially superposed on one another, as a reinforcing element for a tire.

Another subject of the invention is a method of manufacturing a tire as defined hereinabove, in which the set is embedded in at least one elastomer matrix.

In one embodiment, each layer of knit is embedded separately in an elastomer matrix so as to form several plies. The elastomer matrices may be identical or different. The plies thus formed are then at least partially superposed to form the set.

In another embodiment, the layers of knit are at least partially superposed so as to form the set. The set thus formed is then embedded in an elastomer matrix.

In yet another embodiment, a first layer of the elastomer matrix is put in place, then a first layer of knit is positioned on the first layer of the elastomer matrix, then a second layer of the elastomer matrix is positioned on the first layer of knit, then a second layer of knit is positioned on the second layer of the elastomer matrix and finally a third layer of the elastomer matrix is positioned on the second layer of knit.

The invention will be better understood from reading the following description, given solely by way of non-limiting example and with reference to the drawings in which:

FIG. 1 is a view in cross section of a tire according to a first embodiment of the invention comprising a set;

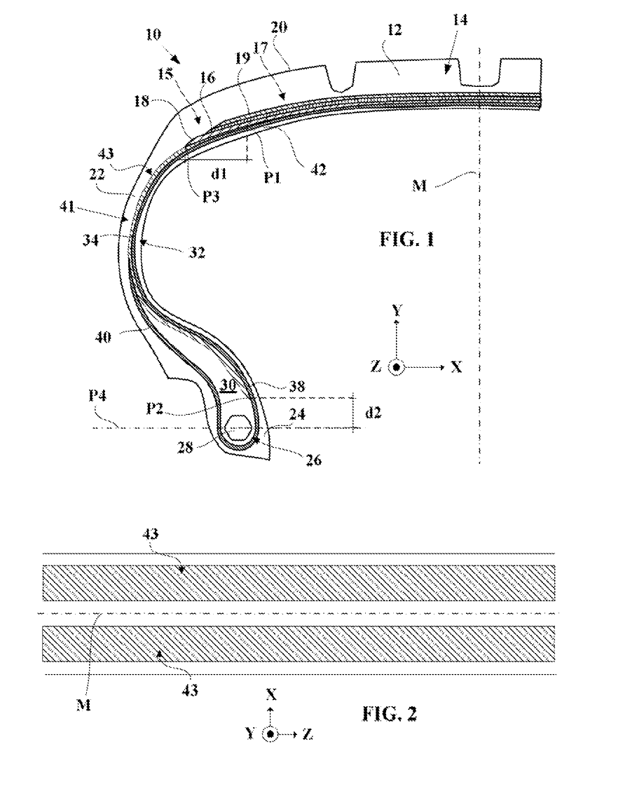

FIG. 2 is a schematic development of the tire of FIG. 1, illustrating the axial distribution of the sets;

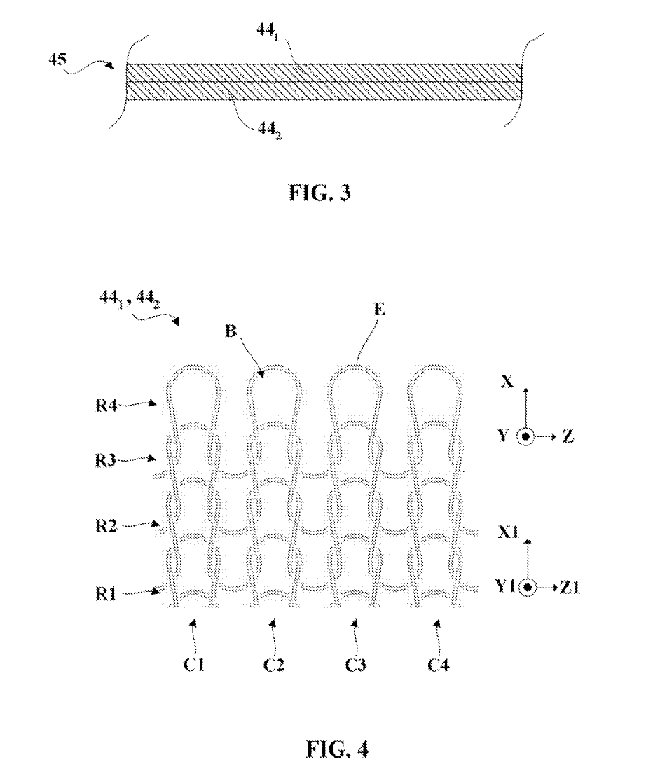

FIG. 3 is a schematic view of the set of the tire of FIG. 1;

FIG. 4 is a detailed view of one of the knits of the set of FIG. 3;

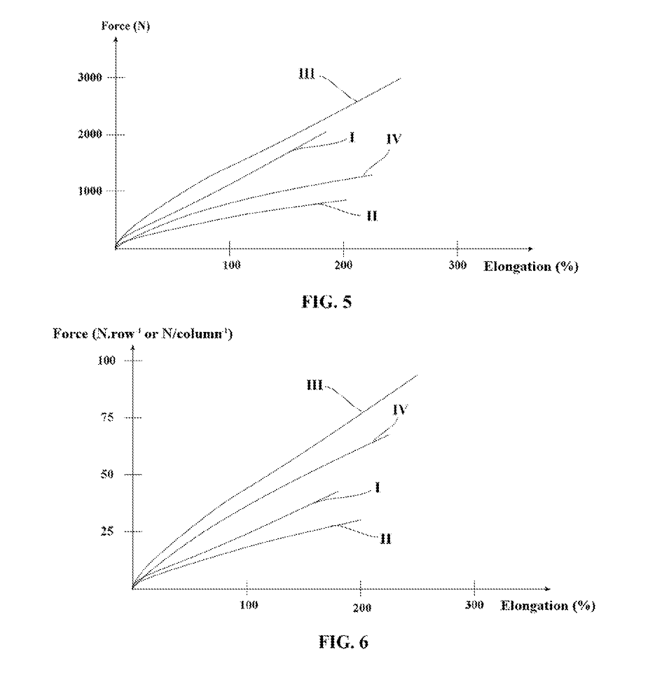

FIGS. 5 and 6 are graphs illustrating force-elongation curves for the knits of

FIGS. 1 to 4 and of a control knit;

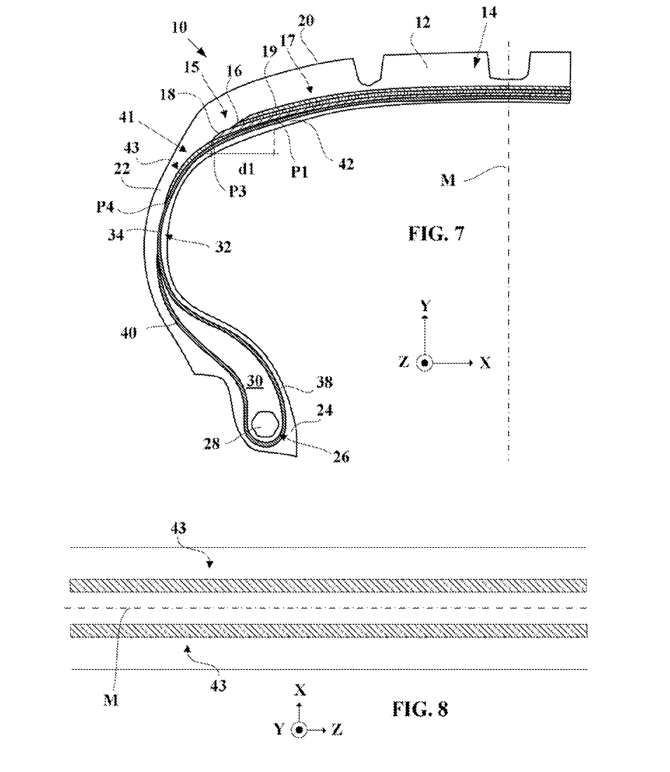

FIGS. 7 and 8 are views respectively similar to those of FIGS. 1 and 2 of a tire according to a second embodiment;

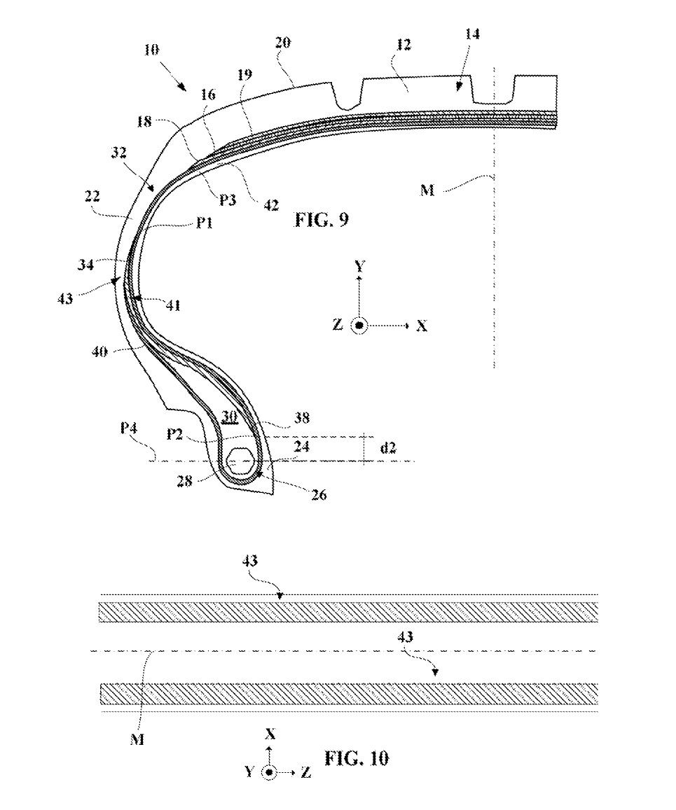

FIGS. 9 and 10 are views respectively similar to those of FIGS. 1 and 2 of a tire according to a third embodiment;

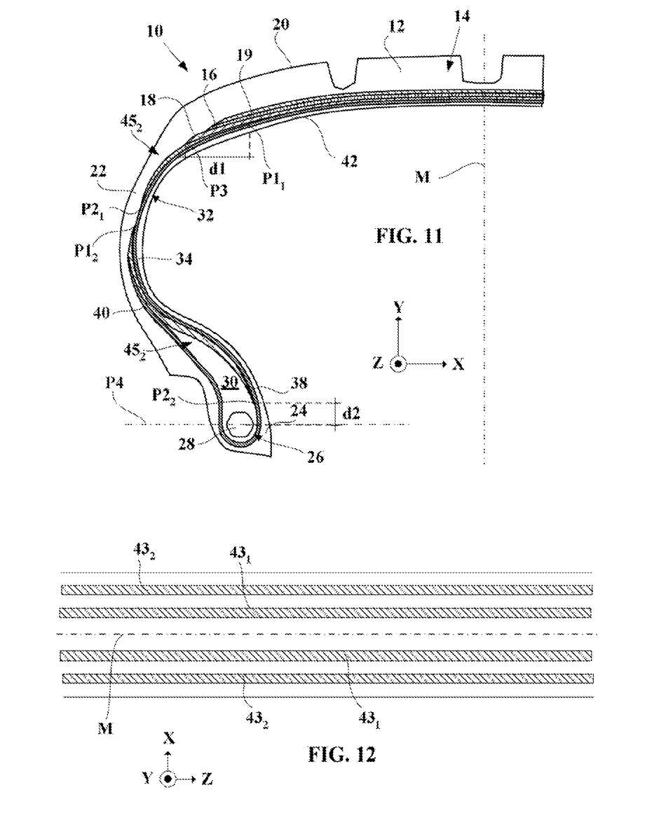

FIGS. 11 and 12 are views respectively similar to those of FIGS. 1 and 2 of a tire according to a fourth embodiment;

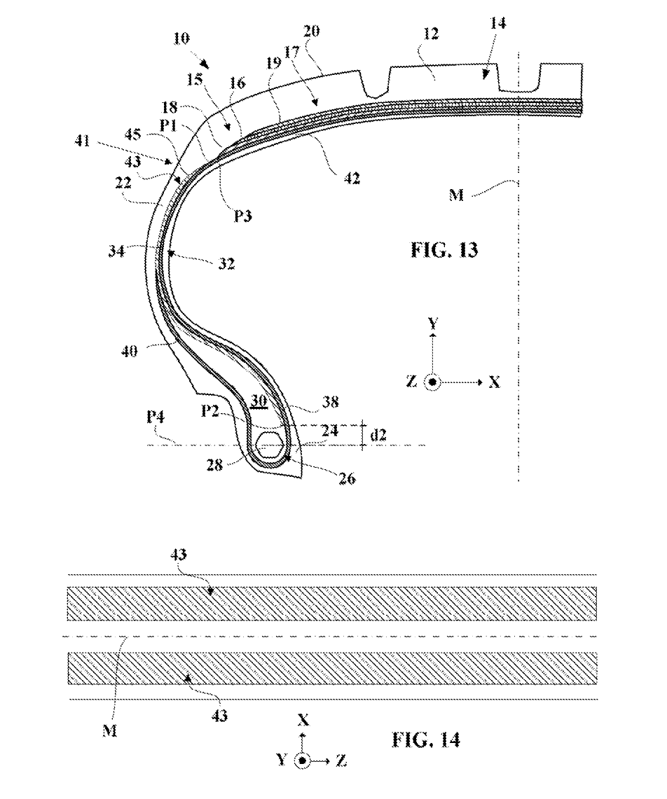

FIGS. 13 and 14 are views respectively similar to those of FIGS. 1 and 2 of a tire according to a fifth embodiment; and

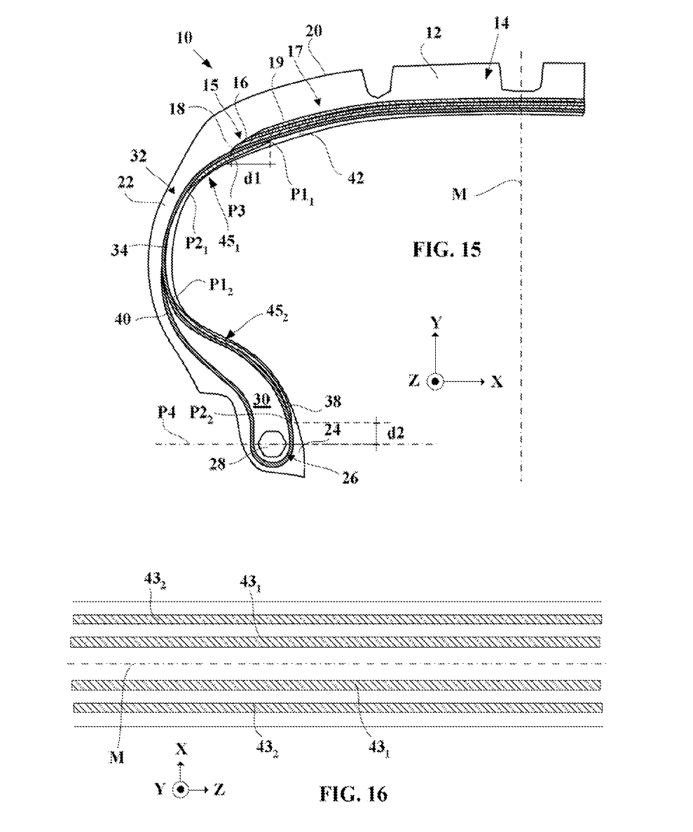

FIGS. 15 and 16 are views respectively similar to those of FIGS. 1 and 2 of a tire according to a sixth embodiment.

In the following description, when using the term “radial”, it is appropriate to make a distinction between several different uses of the word by a person skilled in the art. Firstly, the expression refers to a radius of the tire. It is in that sense that a point A is said to be “radially inside” a point B (or “radially on the inside of” the point B) if it is closer to the axis of rotation of the tire than is the point B. Conversely, a point C is said to be “radially outside” a point D (or “radially on the outside of” the point D) if it is further from the axis of rotation of the tire than is the point D. Progress “radially inwards (or outwards)” will mean progress towards smaller (or larger) radii. It is this sense of the word that applies also when radial distances are being discussed.

On the other hand, a reinforcing element or a reinforcement is said to be “radial” when the reinforcing element or the reinforcing elements of the reinforcement make an angle greater than or equal to 65° and less than or equal to 90° with the circumferential direction.

An “axial” direction is a direction parallel to the axis of rotation of the tire. A point E is said to be “axially inside” a point F (or “axially on the inside of” the point F) if it is closer to the median plane of the tire than is the point F. Conversely, a point G is said to be “axially outside” a point H (or “axially on the outside of” the point H) if it is further from the median plane of the tire than is the point H.

The “median plane” M of the tire is the plane which is normal to the rotation axis of the tire and which is situated equidistantly from the annular reinforcing structures of each bead.

A “circumferential” direction is a direction which is perpendicular both to a radius of the tire and to the axial direction.

Furthermore, any range of values denoted by the expression “between a and b” represents the range of values extending from more than a to less than b (namely excluding the end-points a and b), whereas any range of values denoted by the expression “from a to b” means the range of values extending from the end-point “a” as far as the end-point “b”, namely including the strict end-points “a” and “b”.

Examples of Tires According to the Invention

A frame of reference X, Y, Z corresponding to the usual respectively axial (X), radial (Y) and circumferential (Z) directions of a tire have been depicted in the figures.

FIGS. 1 and 2 depict a tire according to a first embodiment of the invention and denoted by the general reference 10. The tire 10 is substantially of revolution about the axis X. The tire 10 here is intended for a passenger vehicle.

The tire 10 comprises a crown 12 comprising a crown reinforcement 14 comprising a working reinforcement 15 comprising two working plies 16, 18 of reinforcing elements and a protective or hooping reinforcement 17 comprising a protective ply 19. The crown reinforcement 14 is surmounted by a tread 20. Here, the protective reinforcement 17, here the protective ply 19, is interposed radially between the working reinforcement 15 and the tread 20.

Two sidewalls 22 extend the crown 12 radially inwards. The tire 10 further comprises two beads 24 radially on the inside of the sidewalls 22 and each comprising an annular reinforcing structure 26, in this instance a bead wire 28, surmounted by a mass of filling rubber 30, as well as a radial carcass reinforcement 32. The carcass reinforcement 32 is surmounted radially by the crown reinforcement 14.

The carcass reinforcement 32 preferably comprises a single carcass ply 34 of radial textile reinforcing elements, the ply 34 being anchored in each of the beads 24 by being turned up around the bead wire 28 so as to form within each bead 24 a main strand 38 extending from the beads 24 through the sidewalls 22 to the crown 12 and a turnup 40, the radially outer end of the turnup 40 here being substantially midway up the height of the tire 10. The carcass reinforcement 32 thus extends from the beads 24 through the sidewalls 22 to the crown 12. As an alternative, the radial reinforcing elements are made of metal. The tire 10 also comprises an inner liner 42, generally made of butyl, arranged axially and radially on the inside of the carcass reinforcement 32.

The working plies 16, 18 comprise metal or textile reinforcing elements conventional to a person skilled in the art and forming an angle of from 15° and 40°, preferably ranging from 20° to 30° and here equal to 26° with the circumferential direction Z of the tire. The reinforcing elements of the working plies are crossed from one working ply to the other.

The protective ply 19 comprises metal or textile reinforcing elements likewise conventional to a person skilled in the art and forming an angle ranging from 0° to 10° with the circumferential direction Z of the tire.

Furthermore, the tire comprises an additional reinforcement 41 comprising at least one additional ply 43. In the example of FIG. 1, the additional reinforcement 41 comprises an additional ply 43 comprising a set 45 of at least two layers of at least one knit, the two layers being at least partially superposed on one another. In this particular instance, the set 45 comprises two knits 44₁, 44₂, each knit forming a layer. As an alternative, it is possible to conceive of a single knit wound over two turns around the axis of the tire 10, each turn forming one layer of the set 45.

As an alternative, the additional reinforcement 41 comprises two additional plies 43, each additional ply then comprising one knit 44₁, 44₂. In both instances, the set 45 of knits 44₁, 44₂ is arranged axially on the outside of the carcass reinforcement 34. Thus, as illustrated in FIG. 1, each sidewall 22 comprises a set 45 of knits 44₁, 44₂.

The radially outer end P1 of the set 45 is axially on the inside of the axially outer end P3 of the crown ply 18 radially adjacent to the set 45. Furthermore, the radially outer end P1 of the set 45 is interposed radially between the carcass reinforcement 32 and the crown reinforcement 14.

The axial distance d1 between the radially outer end P1 of the set 45 and the axially outer end P3 of the crown ply 18 radially adjacent to the set 45 is greater than or equal to 5 mm, preferably to 10 mm. In this instance, d1=10 mm. In other embodiments, d1 is greater than or equal to 15 mm.

The set 45 extends, in the bead, axially between the main strand 38 and the turnup 40 of the carcass reinforcement 32. As an alternative, it is possible to conceive of an embodiment in which the set 45 extends, in the bead, axially on the outside of the turnup 40.

The radial distance d2 between the radially inner end P2 of the set 45 and the radial mid-plane P4 of the annular structure 26 of the bead 24 is less than or equal to 15 mm, preferably less than or equal to 10 mm, and more preferably less than or equal to 5 mm. Here d2=5 mm.

Each working ply 16, 18, protective ply 19, carcass ply 34 and additional ply 43 comprises an elastomer matrix in which the reinforcing elements of the corresponding ply are embedded. The compositions of the elastomer matrices of the working plies 16, 18, protective ply 19, carcass ply 34 and additional ply 43 are compositions that are conventional for skimming reinforcing elements and containing in the conventional way a diene elastomer, for example natural rubber, a reinforcing filler, for example carbon black and/or silica, a crosslinking system, for example a vulcanization system, preferably containing sulphur, stearic acid and zinc oxide, and possibly a vulcanization retardant and/or accelerator and/or various additives.

The set 45 is depicted in FIG. 3. In this particular instance, the two knits 44₁, 44₂ are identical and have the same dimensions so that they are completely superposed on one another in a radial and/or axial direction of the tire 10, in this instance in the axial direction X of the tire 10. However, it is possible to conceive of knits 44₁, 44₂ of different natures and/or different dimensions.

As depicted in FIG. 4, each knit 44₁, 44₂ comprises columns C1, C2, C3, C4 of loops B and rows R1, R2, R3, R4 of loops B. The loops B of one and the same column Ci are arranged one after another substantially in an overall direction referred to as the main direction X1. The loops B of one and the same row Ri are arranged one beside the other substantially in an overall direction referred to as the transverse direction Z1.

The main X1 and transverse Z1 directions of each knit 44₁, 44₂ make, with respect to one another, an angle of between 75° and 105°, preferably between 85° and 95°. Here, the main X1 and transverse Z1 directions are substantially perpendicular to one another.

The transverse overall direction Z1 makes an angle at most equal to 10° with the circumferential direction Z of the tire 10 and in this instance an angle equal to 0°, the transverse overall direction Z1 of each knit 44₁, 44₂ being substantially parallel to the circumferential direction Z of the tire. The main overall direction X1 of the knit 44 is substantially parallel to the radial direction X of the tire.

Each knit 44₁, 44₂ has a construction of the jersey type and has been produced using a knitting method conventional to those skilled in the art in this field. Each knit 44₁, 44₂ has, in the direction Y1, a thickness ranging from 0.3 to 3 mm, preferably 0.8 to 1.7 mm and here equal to 0.8 mm.

The surface density of stitches in the knit, as measured in accordance with standard NF EN 14971, is less than or equal to 700 stitches·cm⁻², preferably less than or equal to 100 stitches·cm⁻² and more preferably, less than or equal to 75 stitches·cm⁻². The surface density of stitches in the knit is also greater than or equal to 15 stitches·cm⁻², preferably greater than or equal to 25 stitches·cm⁻² and more preferably, greater than or equal to 30 stitches·cm⁻². In this particular instance, the surface density is equal to 55 stitches·cm².

FIGS. 5 and 6 depict force-elongation curves obtained by applying standard ISO 13934-1:2013 to each knit 44₁, 44₂ embedded in a standard elastomer matrix as defined hereinabove. In this example, the standard elastomer matrix comprises a diene elastomer, a reinforcing filler, for example carbon black, a vulcanization system and the usual additives employed by those skilled in the art. The compositions of these standard matrices are within the competence of a person skilled in the art who will know how to formulate these in order to obtain the desired apparent modulus MA100 at 100% elongation, in this instance 1.6 MPa±0.2 MPa (ASTM D412-1998, test specimen “C”). Moreover, the apparent modulus MA10 at 10% elongation of the standard elastomer matrix used here is equal to 3.3 MPa±0.5 MPa and the apparent modulus MA300 at 300% elongation of the standard elastomer matrix used here is equal to 1.7 MPa±0.3 MPa (ASTM D412-1998, test specimen “C”).

Curves I (main direction) and II (transverse direction) correspond to each knit 44₁, 44₂ described hereinabove. Curves III (main direction) and IV (transverse direction) correspond to a control knit used by itself in the tire Q1 of the comparative tests below.

As can be seen in FIGS. 5 and 6, each knit 44₁, 44₂ has particular properties of elongation at break and maximum force which are measured in accordance with standard ISO 13934-1:2013, and properties of force at 10%, 50% and 100% elongation which are determined from a force-elongation curve obtained by applying standard ISO 13934-1:2013. The number of rows and/or columns is measured in accordance with standard NF EN 14971.

Each knit 44₁, 44₂ has, in the main overall direction X1 and/or the transverse overall direction Z1, and in this instance in both directions X1 and Z1, a force at 100% elongation that is greater than or equal to 50 N, preferably 200 N and more preferably 500 N and less than or equal to 1500 N, preferably 1400 N and more preferably 1300 N. Under high cornering loads, the set 45 is heavily loaded. It has been found that, under heavy cornering loadings, the elongation of the knits in the circumferential direction of the tire 10 is of the order of 100% in the circumferential direction of the tire 10. Thus, during these high loads, in order to obtain high cornering stiffness, it is desirable for the force of the set to be relatively high, as is the case for the knits of curves I and II. For preference, the force at 100% elongation in the main direction X1 is greater than or equal to 150 N, preferably 700 N and more preferably 1000 N, and the force at 100% elongation in the transverse direction Z1 is greater than or equal to 50 N, preferably 500 N. More preferably still, on the one hand, each knit 44₁, 44₂ has a force at 100% elongation greater than or equal to 0.5 N·row⁻¹ and/or 0.5 N·column⁻¹, preferably 5 N·row⁻¹ and/or 5 N·column⁻¹, and more preferably 15 N·row⁻¹ and/or 15 N·column⁻¹ in the main direction and/or the transverse direction.

On the other hand, according to the invention, each knit 44₁, 44₂ has a force at 100% elongation that is less than or equal to 40 N·row⁻¹ and/or 40 N·column⁻¹ in the main and/or transverse direction. For preference, the force at 100% elongation is less than or equal to 35 N·row⁻¹ and/or 35 N·column⁻¹ in the main and/or transverse direction.

For preference, each knit 44₁, 44₂ has, in the main overall direction X1 and/or the transverse overall direction Z1, a force at 50% elongation greater than or equal to 50 N, preferably 250 N, and less than or equal to 1000 N, preferably 700 N. More preferably, on the one hand, each knit 44₁, 44₂ has a force at 50% elongation that is greater than or equal to 0.5 N·row⁻¹ and/or 0.5 N·column⁻¹, preferably 2.5 N·row⁻¹ and/or 2.5 N·column⁻¹ and more preferably 10 N·row⁻¹ and/or 10 N·column⁻¹ in the main and/or transverse direction. On the other hand, each knit 44₁, 44₂ has a force at 50% elongation less than or equal to 25 N·row⁻¹ and/or 25 N·column⁻¹, preferably 20 N·row⁻¹ and/or 20 N·column⁻¹ in the main and/or transverse direction.

For preference, each knit 44₁, 44₂ has, in the main overall direction X1 and/or the transverse overall direction Z1, a force at 10% elongation greater than or equal to 5 N, preferably 50 N, and less than or equal to 700 N, preferably 600 N. More preferably, on the one hand, each knit 44₁, 44₂ has a force at 10% elongation that is greater than or equal to 0.05 N·row⁻¹ and/or 0.05 N·column⁻¹, preferably 1 N·row⁻¹ and/or 1 N·column⁻¹ and more preferably 2 N·row⁻¹ and/or 2 N·column⁻¹ in the main and/or transverse direction. On the other hand, each knit 44₁, 44₂ has a force at 10% elongation less than or equal to 9 N·row⁻¹ and/or 9 N·column⁻¹, preferably 7 N·row⁻¹ and/or 7 N·column⁻¹ in the main and/or transverse direction.

Preferably, the force at 50% elongation in the main direction X1 is greater than or equal to 120 N, preferably 500 N and the force at 50% elongation in the transverse direction Z1 is greater than or equal to 50 N, preferably 300 N. Preferably, the force at 10% elongation in the main direction X1 is greater than or equal to 30 N, preferably 170 N and the force at 10% elongation in the transverse direction Z1 is greater than or equal to 10 N, preferably 80 N.

For preference, each knit 44₁, 44₂ has, in the main overall direction X1 and/or the transverse overall direction Z1, a maximum force greater than or equal to 600 N and less than or equal to 2200 N. Each knit 44₁, 44₂ corresponding to curves I and II individually has a mechanical strength that is modest and less than that of the knit corresponding to curves III and IV. The set on the other hand has a mechanical strength that is relatively high and greater than that of the knit corresponding to curves III and IV alone. This feature is notably advantageous in the case of impacts between the tire and potential obstacles known as “road hazards”. For preference, the maximum force in the main direction X1 is greater than or equal to 600 N and the maximum force in the transverse direction Z1 is greater than or equal to 600 N. For preference, the maximum force in the main direction X1 is less than or equal to 2200 N, and the maximum force in the transverse direction Z1 is less than or equal to 1500 N. More preferably, on the one hand, each knit 44₁, 44₂ has a maximum force greater than or equal to 5 N·row⁻¹ and/or 5 N·column⁻¹, preferably 10 N·row⁻¹ and/or 10 N·column⁻¹ and more preferably 30 N·row⁻¹ and/or 30 N·column⁻¹ in the main and/or transverse direction. On the other hand, each knit 44₁, 44₂ has a maximum force less than or equal to 70 N·row⁻¹ and/or 70 N·column⁻¹, preferably 60 N·row⁻¹ and/or 60 N·column⁻¹ in the main and/or transverse direction.

For preference, each knit 44₁, 44₂ has, in the main overall direction X1 and/or the transverse overall direction Z1, an elongation at break greater than or equal to 30%, preferably 100% and less than or equal to 1200%, preferably 250%. By limiting the elongation at break of each knit 44₁, 44₂ corresponding to the curves I and II, it is ensured that the knit will not deform needlessly, the elastomer matrix adjacent to the set in all cases running the risk of breaking before the knit. For preference, the elongation at break in the main direction X1 is less than or equal to 700%, preferably 250%, and the elongation at break in the transverse direction Z1 is less than or equal to 1200%, preferably 250%. For preference, the elongation at break in the main direction X1 is greater than or equal to 150% and the elongation at break in the transverse direction Z1 is greater than or equal to 150%.

Each knit 44₁, 44₂ is made up of one or more filamentary elements E of a material selected from a polyester, a polyamide, a polyketone, a cellulose, a mineral fibre, a natural fibre, an elastomeric material or a mixture of these materials.

The or each filamentary element E comprises at least one multifilament strand comprising several elementary monofilaments. In this particular instance, the or each filamentary element E comprises two strands of nylon each of 47 tex each overtwisted at 250 turns·m⁻¹ in a first direction then plied in a helix around one another at 250 turns·m⁻¹ in a second direction that is opposite to the first direction.

A method of manufacturing the tire 10 as described hereinabove will now be described. Only the main steps relating to the invention will be described, it being easy for the other steps to be carried out on the basis of the general knowledge of a person skilled in the art.

During the course of the method, a green tire comprising the beads 24, the sidewalls 22 and the carcass reinforcement 32, in this instance the carcass ply 34, is formed.

In a first embodiment of the method, each knit 44₁, 44₂ is embedded individually or collectively in an elastomer matrix so as to obtain one or two additional plies 43, for example by individually skimming each knit 44₁, 44₂ or by collectively skimming the knits 44₁, 44₂ between two skim strips of elastomer matrix. This or these additional ply or plies 43 is or are then added to the green tire formed beforehand. Next, the crown reinforcement 14 and the tread 20 are added.

In a second embodiment, a first strip of elastomer matrix is added to the green tire. Then the set 45 of knits 44₁, 44₂ is added to the first strip of elastomer matrix. Next, a second strip of elastomer matrix is added to the set 45 of knits 44₁, 44₂. Finally, the crown reinforcement 14 and the tread 20 are added. When the green tire is cured to form the tire 10, the elastomer matrix of the first and second strips flows through the set 45 of knits 44₁, 44₂. Thus the set 45 of knits 44₁, 44₂ becomes embedded in at least one elastomer matrix.

In this second embodiment, the set 45 forms a monolithic ring having an axis of revolution. The ring is radially deformable, namely deformable at right angles to its axis of revolution, between a rest position and a deformed position. Thus the set 45 is deformed radially from its rest state into its deformed state and then added axially around the green tire in its deformed state, then the set 45 is released from its deformed state so that the knit tightly encircles the green tire. Once in position on the green tire, the axis of revolution of the monolithic ring is substantially parallel to and coincident with the axis of the tire.

In a third embodiment, a first strip of elastomer matrix is added to the green tire. Then the first knit 44₁ is added to the first strip of elastomer matrix. Then a second strip of elastomer matrix is added to the first knit 44₁. Then the second knit 44₂ is added to the second strip of elastomer matrix. Next, a third strip of elastomer matrix is added to the second knit 44₂. Finally, the crown reinforcement 14 and the tread 20 are added. As the green tire is cured to form the tire 10, the elastomer matrix of the first, second and third strips flows through the set 45 of knits 44₁, 44₂. Thus the set 45 of knits 44₁, 44₂ becomes embedded in at least one elastomer matrix.

Second, third, fourth, fifth and sixth embodiments of the invention will now be described with reference respectively to FIGS. 7, 8 and 9, 10 and 11, 12 and 13, 14 and 15, 16. Elements similar to those described in the previous embodiment are denoted by identical references.

Unlike the tire according to the first embodiment, the tire according to the second embodiment of FIGS. 7 and 8 is such that the radial distance d2 between the radially inner end P2 of the set 45 and the radial mid-plane P4 of the annular structure 26 of the bead 24 is greater than 15 mm.

Unlike the tire according to the first embodiment, the tire according to the third embodiment in FIGS. 9 and 10 is such that the radially outer end P1 of the set 45 is axially on the outside with respect to the axially outer end P3 of the crown ply 18 radially adjacent to the set 45.

The tire according to the fourth embodiment of FIGS. 11 and 12 comprises two sets 451 and 452 of knits, in this instance the sets of knits 45 of the second and third embodiments respectively. Each set 451 and 452 comprises a radially outer end denoted P1₁ and P1₂ respectively, and a radially inner end respectively denoted P2₁ and P2₂.

Unlike the tire according to the first embodiment, the tire according to the fifth embodiment in FIGS. 13 and 14 is such that the radially outer end P1 of the set 45 is axially on the outside with respect to the axially outer end P3 of the crown ply 18 radially adjacent to the set 45.

Unlike the tire according to the fourth embodiment in FIGS. 11 and 12, the tire of the sixth embodiment in FIGS. 15 and 16 comprises two sets 451, 452, in this instance the sets 45 of the second and third embodiments respectively, arranged axially on the inside of the carcass reinforcement 32.

Comparative Tests

A tire 10 according to the invention, three control tires Q1, Q2 and Q3, and three tires T1, T2 and T3 of the prior art were compared. The tire 10 according to the invention has an architecture identical to that of the tire according to the first embodiment and comprises two knits each made up of one or more filamentary elements made of nylon. Each control tire Q1, Q2, Q3 has an architecture identical to that of the tire 10 except that each ply comprises just one single knit rather than two superposed layers of knit.

The characteristics of the knits used are described in table 1 (properties relating to maximum force, elongation at break, elongation at 10%, 50% and 100% obtained by applying standard ISO 13934-1:2013 to the or each knit embedded in the standard elastomer matrix), table 2 (properties relating to the surface density of stitches in accordance with standard NF EN 14971 of 2006) hereinbelow and table 3 (properties relating to maximum force and forces at 10%, 50% and 100% elongation per row and per column) hereinbelow.

TABLE 1

| Tire | 10 | Q1 | Q2 | Q3 |
|---|---|---|---|---|
| Nature of the strand | N47/2 | N140/2 | N94/2 | N140/2 |
| Construction of the knit | Jersey | Jersey | Welted | Interlocked |
| | | | jersey | rib |
| Number of layers of knit | 2 | 1 | 1 | 1 |

Main direction X1

| | | | | |
|---|---|---|---|---|
| Maximum force (N) | 2067 | 3002 | 1869 | 4840 |
| Elongation at break (%) | 180 | 250 | 129 | 485 |
| Force at 100% elongation | 1161 | 1444 | 1535 | 1413 |
| Force at 50% elongation | 645 | 903 | 835 | 1112 |
| Force at 10% elongation | 203 | 318 | 308 | 530 |

Transverse direction Z1

| | | | | |
|---|---|---|---|---|
| Maximum force (N) | 1346 | 1380 | 1451 | 2905 |
| Elongation at break (%) | 180 | 228 | 225 | 306 |
| Force at 100% elongation | 822 | 804 | 820 | 1265 |
| Force at 50% elongation | 484 | 515 | 435 | 890 |
| Force at 10% elongation | 173 | 176 | 127 | 345 |

TABLE 2

| Tire | 10 | Q1 | Q2 | Q3 |
|---|---|---|---|---|
| Nature of the strand | N47/2 | N140/2 | N94/2 | N140/2 |
| Construction of the | Jersey | Jersey | Welted | Interlocked |
| knit | | | jersey | rib |
| Number of layers of | 2 | 1 | 1 | 1 |
| knit | | | | |
| Method used in | B | B | B | B |
| standard NF EN 14971 | | | | |
| Measurement face | Technical | Technical | Technical | Technical |
| | right side | right side | right side | right side |
| Mean of individual | 5.8 | 4.1 | 3 | 3.6 |
| results (columns/cm) | | | | |
| Mean of individual | 9.6 | 6.4 | 5 | 5.7 |
| results (rows/cm) | | | | |
| Surface density | 55 | 26 | 15 | 21 |
| (stitches/cm²) | | | | |

TABLE 3

| Tire | 10 | Q1 | Q2 | Q3 |
|---|---|---|---|---|
| Nature of the strand | N47/2 | N140/2 | N94/2 | N140/2 |
| Construction of the knit | Jersey | Jersey | Welted | Interlocked |
| | | | jersey | rib |
| Number of layers of knit | 2 | 1 | 1 | 1 |
| Surface density | 55 | 26 | 15 | 21 |
| (stitches/cm²) | | | | |

Main direction X1 (values expressed in N per row)

| | | | | |
|---|---|---|---|---|
| Maximum force (N) | 43.1 | 93.8 | 74.7 | 169.8 |
| Force at 100% elongation | 24.2 | 45.1 | 61.4 | 49.6 |
| Force at 50% elongation | 13.4 | 28.2 | 33.4 | 39.0 |
| Force at 10% elongation | 4.2 | 9.9 | 12.3 | 18.6 |

Transverse direction Z1 (values expressed in N per column)

| | | | | |
|---|---|---|---|---|
| Maximum force (N) | 46.4 | 67.3 | 96.7 | 161.4 |
| Force at 100% elongation | 28.3 | 39.2 | 54.7 | 70.3 |
| Force at 50% elongation | 16.7 | 25.1 | 29 | 49.4 |
| Force at 10% elongation | 6 | 8.6 | 8.4 | 19.2 |

The tire T1 is identical to the tire 10 except that it has no knit. The tire T2 comprises, in addition to the elements of the tire T1, a second carcass ply. The tire T3 is identical to the tire T1 except that its sidewalls have an additional thickness of 10 mm by comparison with that of the sidewalls of the tire T1.

The various tires 10, Q1 to Q3 and T1 to T3 were subjected to a drift thrust Dz test and to a rolling resistance test as described hereinbelow. The mass of each tire 10, Q1 to Q3 and T1 to T3 was also measured.

The results relating to drift thrust and to mass are given to base 100 with respect to the tire T1. Thus, for drift thrust Dz, the greater the extent to which the value is above 100, the better is the drift thrust of the tire tested compared with the tire T1. In the case of mass, the greater the extent to which the value is lower than 100, the heavier the tire tested is in relation to the tire T1.

The results relating to rolling resistance are given to base 100 with respect to the tire T3. The greater the extent to which the value is below 100, the higher the rolling resistance. Obviously, the objective is to get the lowest possible rolling resistance.

To measure the drift thrust Dz, each tire was driven at a constant speed of 80 km/h on a suitable automatic machine (machine of the “flat-track” type marketed by MTS), varying the load denoted “Z”, at a relatively large cornering angle of 8 degrees, and the drift thrust was measured continuously and the cornering stiffness denoted “D” (corrected for the thrust at zero drift) was identified by recording, by way of sensors, the transverse load on the wheel as a function of this load Z; the cornering stiffness is thus obtained. The reported value for Dz is thus obtained for a chosen load here of 482 daN.

The rolling resistance was measured on a dynamometer according to the ISO 87-67 (1992) method.

The results of these tests are collated in table 4 below.

TABLE 4

| | T1 | T2 | T3 | Q1 | Q2 | Q3 | 10 |
|---|---|---|---|---|---|---|---|
| Weight (base 100) | 100 | 93 | 81 | 97 | 96 | 96 | 94 |
| Dz (base 100) | 100 | 101 | 108 | 104 | 105 | 104 | 107 |
| Rolling resistance | / | / | 100 | 99 | 102 | 101 | 99 |
| (base 100) | | | | | | | |

It will be noted that the tire 10 according to the invention has a mass relatively similar to that of the tire T1 and, in any event, lower than that of the tire T2 and especially that of the tire T3. Furthermore, it will be noted that the tire 10 according to the invention has a cornering stiffness Dz higher than those of the tires T1 and T2 and similar to that of the tire T3. Furthermore, even though the mass of the tire 10 according to the invention is slightly higher than that of the control tires Q1 to Q3, the cornering stiffness of the tire 10 according to the invention is itself far superior to those of the control tires Q1 to Q3. Thus, the tire 10 according to the invention offers excellent cornering stiffness and a relatively restrained mass. Moreover, the tire 10 according to the invention offers a restrained rolling resistance almost identical to that of the tire T3.

The invention is not limited to the embodiments described above.

The set could be arranged in other locations in the tire than those described hereinabove, for example in the crown reinforcement, radially on the outside of the working plies or even in a lower region, for example in the bead.

It may also be possible to combine the features of the various embodiments described or envisaged above, as long as these are compatible with one another.

1. A tire comprises at least one set of at least two layers of at least one knit, the two layers being at least partially superposed on one another, the or each knit comprising:
columns of loops, the loops of one and the same column being arranged one after the other substantially in an overall direction referred to as the main direction;
rows of loops, the loops of one and the same row being arranged one beside the other substantially in an overall direction referred to as the transverse direction;
the or each knit having a force at 100% elongation less than or equal to 40 N·row⁻¹ and/or 40 N·column⁻¹, the force at 100% elongation being determined from a force-elongation curve obtained by applying standard ISO 13934-1:2013 to the or each knit embedded in the standard elastomer matrix and the number of rows and/or columns being measured in accordance with standard NF EN 14971.

2. The tire according to the claim 1, wherein the or each knit having a force at 100% elongation less than or equal to 35 N·row⁻¹ and/or 35 N·column⁻¹, the force at 100% elongation being determined from a force-elongation curve obtained by applying standard ISO 13934-1:2013 to the or each knit embedded in the standard elastomer matrix and the number of rows and/or columns being measured in accordance with standard NF EN 14971.

3. The tire according to claim 1, wherein the or each knit has a force at 100% elongation greater than or equal to 0.5 N·row⁻¹ and/or 0.5 N·column⁻¹, the force at 100% elongation being determined from a force-elongation curve obtained by applying standard ISO 13934-1:2013 to the or each knit embedded in a standard elastomer matrix and the number of rows and/or columns being measured in accordance with standard NF EN 14971.

4. The tire according to claim 1, wherein the or each knit has a force at 100% elongation less than or equal to 40 N·row⁻¹ and/or 40 N·column⁻¹, the force at 100% elongation being determined from a force-elongation curve obtained by applying standard ISO 13934-1:2013 to the or each knit embedded in the standard elastomer matrix and the number of rows and/or columns being measured in accordance with standard NF EN 14971.

5. The tire according to claim 1, wherein the or each knit has a force at 50% elongation greater than or equal to 0.5 N·row⁻¹ and/or 0.5 N·column⁻¹, the force at 50% elongation being determined from a force-elongation curve obtained by applying standard ISO 13934-1:2013 to the or each knit embedded in the standard elastomer matrix and the number of rows and/or columns being measured in accordance with standard NF EN 14971.

6. The tire according to claim 1, wherein the or each knit has a force at 50% elongation less than or equal to 25 N·row⁻¹ and/or 25 N·column⁻¹, the force at 50% elongation being determined from a force-elongation curve obtained by applying standard ISO 13934-1:2013 to the or each knit embedded in the standard elastomer matrix and the number of rows and/or columns being measured in accordance with standard NF EN 14971.

7. The tire according to claim 1, wherein the or each knit has a maximum force greater than or equal to 5 N·row⁻¹ and/or 5 N·column⁻¹, the maximum force being measured in accordance with standard ISO 13934-1:2013 applied to the or each knit embedded in the standard elastomer matrix and the number of rows and/or columns being measured in accordance with standard NF EN 14971.

8. The tire according to claim 1, wherein the or each knit has a maximum force less than or equal to 70 N·row⁻¹ and/or 70 N·column⁻¹, the maximum force being measured in accordance with standard ISO 13934-1:2013 applied to the or each knit embedded in the standard elastomer matrix and the number of rows and/or columns being measured in accordance with standard NF EN 14971.

9. The tire according to claim 1, wherein the main and transverse directions make, with respect to one another, an angle of between 75° and 105°.

10. The tire according to claim 1, wherein the surface density of stitches of the or each knit, measured in accordance with standard NF EN 14971, is greater than or equal to 15 stitches·cm⁻².

11. (canceled)

12. The tire according to claim 1, comprising a carcass reinforcement anchored in two beads and surmounted radially by a crown reinforcement itself surmounted by a tread which is connected to the beads by two sidewalls, each sidewall comprising the set of at least two layers of at least one knit.

13. The tire according to claim 12, the radially outer end of the set of at least two layers of at least one knit is axially on the inside with respect to the axially outer end of a crown ply radially adjacent to the set.

14. (canceled)

15. The tire according to claim 12, wherein the radially outer end of the set of at least two layers of at least one knit is interposed radially between the carcass reinforcement and the crown reinforcement.

16. The tire according to claim 12, wherein the carcass reinforcement is anchored in each bead by being turned up around an annular structure of the bead so as to form a main strand and a turnup.

17. (canceled)

18. Method of manufacturing a tire with at least one set of at least two layers of at least one knit, the two layers being at least partially superposed on one another, as a reinforcing element for a tire, the steps for forming the or each knit comprising:
arranging columns of loops, with the loops of one and the same column being arranged one after the other substantially in an overall direction referred to as the main direction;
arranging rows of loops, with the loops of one and the same row being arranged one beside the other substantially in an overall direction referred to as the transverse direction;
providing the or each knit with a force at 100% elongation less than or equal to 40 N·row⁻¹ and/or 40 N·column⁻¹, the force at 100% elongation being determined from a force-elongation curve obtained by applying standard ISO 13934-1:2013 to the or each knit embedded in the standard elastomer matrix and the number of rows and/or columns being measured in accordance with standard NF EN 14971; and
embedding the set in at least one elastomer matrix.

19. (canceled)
